(19) United States
(12) Patent Application Publication
(10) Pub. No.: US 2012/0306539 A1
(43) Pub. Date: Dec. 6, 2012

(54) FRACTIONAL-N CLOCK GENERATOR AND METHOD THEREOF

(75) Inventor: CHOU MIN CHUNG, Miaoli County (TW)

(73) Assignee: RAYDIUM SEMICONDUCTOR CORPORATION, HSINCHU (TW)

(21) Appl. No.: 13/480,972

(22) Filed: May 25, 2012

(30) Foreign Application Priority Data
Jun. 3, 2011 (TW) 100119513

(51) Int. Cl. G06F 1/08

(52) U.S. Cl. 327/39

(57) ABSTRACT

A fractional-n clock generator includes a first digital delay line module, a second delay line module, an address generator and a selector. The first delay line module receives a frequency-divided clock signal and generates first delay signals having different phase differences with respect to the clock signal. The second delay line module receives the clock signal and generates second delay signals having different phase differences with respect to the clock signal. The address generator selects one of the first delay signals as an output signal of the first delay line module and one of the second delay signals as an output signal of the second delay line module. The selector selects one of the output signals of the first delay line module and the second delay line module as an output signal. A delay of the first delay line module is different from that of the second delay line module.

### BACKGROUND

1. Technical Field

The present invention relates to a clock generator and, more particularly, to a fractional-n clock generator and a method of generating a fractional-n clock.

2. Related Art

In circuit designs, a signal with a particular frequency is often required, and a circuit configured to generate the signal with the particular frequency is called a frequency synthesizer. For example, in analog circuits, a Miller frequency divider is a kind of frequency divider that uses a mixer, a low pass filter and an amplifier to generate a frequency-divided signal of an input signal. In digital circuits, a counter can be utilized to generate a frequency-divided signal by dividing an input signal by an integer. However, some applications require a signal or spread spectrum signal at a particular frequency, which is not a frequency-divided signal generated by dividing an input signal by an integer, to resist electromagnetic interference (EMI). Accordingly, a circuit that can generate a clock that is frequency divided by a fraction is required.

FIG. 1 illustrates a prior art fractional-n clock generator 100. As illustrated in FIG. 1, the fractional-n clock generator 100 includes a first frequency divider 102, a second frequency divider 104, a selector 106, a digital delay line module 108 and an address generator 110. The first frequency divider 102, configured to generate a frequency-divided signal by dividing its input signal by N, receives an external clock signal CLKIN to generate a frequency-divided clock signal CLKIN/N. The second frequency divider 104, configured to generate a frequency-divided signal by dividing its input signal by N+1, receives an external clock signal CLKIN to generate a frequency-divided clock signal CLKIN/(N+1). The selector 106 is configured to select one of the output signals of the first frequency divider 102 and the second frequency divider 104 as an input signal to the digital delay line module 108. The digital delay line module 108, configured to receive a frequency-divided clock signal, includes a plurality of delay units to generate a plurality of delay signals having different phase differences with respect to the frequency-divided clock signal. The address selector 110 is configured to select one of the delay signals as an output signal CLKO of the digital delay line module 108.

FIG. 2 is a waveform diagram illustrating waveforms of several signals of the fractional-n clock generator 100. According to the present embodiment, N is equal to 1. That is, the first frequency divider 102 is configured to generate the frequency-divided clock signal CLKIN/1 by dividing its input signal by 1, and the second frequency divider 104 is configured to generate the frequency-divided clock signal CLKIN/2 by dividing its input signal by 2. As illustrated in FIG. 2, the fractional-n clock generator 100 is configured to generate the fractional-n clock signal by dividing its input external clock signal CLKIN by a fraction between 1 and 2. During the first three clock cycles, the selector 106 selects the output of the first frequency divider 102 as the input signal to the digital delay line module 108, and the address generator 110 configures the digital delay line module 108 to incrementally increase the number of stages of the delay units for each selection for the output signal. During the fourth clock cycle, because the final output signal is delayed by more than one period with respect to the frequency-divided clock signal CLKIN/1, and the delay of the digital delay line module 108 does not exceed one period of the frequency-divided clock signal, if the frequency-divided clock signal CLKIN/1 is still used as a reference signal for delay, an undesired pulse will be generated on the output signal. Accordingly, during the fourth cycle, the selector 106 selects the frequency-divided clock signal CLKIN/2 of the second frequency divider 104 as the input signal of the digital delay line module 108 so as to skip the undesired pulse. As illustrated in FIG. 2, the dot-dashed line portion of the output signal is generated based on the frequency-divided signal CLKIN/2. However, the fractional-n clock generator 100 can only reduce the frequency of the external clock signal CLKIN and cannot realize applications requiring increase of frequency, and is therefore unsuitable for the requirements of the current circuit designs.

### SUMMARY

The present invention discloses a fractional-n clock generator, which includes a first digital delay line module, a second digital delay line module, an address generator and a selector. The first digital delay line module is configured to receive a frequency-divided clock signal and include a plurality of first delay units to generate a plurality of first delay signals having different phase differences with respect to the frequency-divided clock signal. The second digital delay line module, configured to receive the frequency-divided clock signal, includes a plurality of second delay units to generate a plurality of second delay signals having different phase differences with respect to the frequency-divided clock signal. The address generator is configured to select one of the first delay signals as an output signal of the first digital delay line module and select one of the second delay signals as an output signal of the second digital delay line module. The selector is configured to select one of the output signals of the first digital delay line module and the second digital delay line module as an output signal. A delay of the first digital delay line module is not equal to a delay of the second digital delay time module.

The present invention discloses a fractional-n clock generation method, including the steps of: generating a plurality of first delay signals having different phase differences with respect to a frequency-divided clock signal, and selecting one of the first delay signals as a first delay output signal; generating a plurality of second delay signals having different phase differences with respect to the frequency-divided clock signal, and selecting one of the second delay signals as a second delay output signal; and selecting one of the first delay output signal and the second delay output signal as an output signal.

The foregoing has outlined rather broadly the features and technical advantages of the present invention in order that the detailed description of the invention that follows may be better understood. Additional features and advantages of the invention will be described hereinafter, and form the subject of the claims of the invention. It should be appreciated by those skilled in the art that the conception and specific embodiment disclosed might be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

The objectives and advantages of the present invention will become easily comprehensible upon reading the following description and upon reference to the accompanying drawings, in which:

FIG. 1 illustrates a prior art fractional-n clock generator;

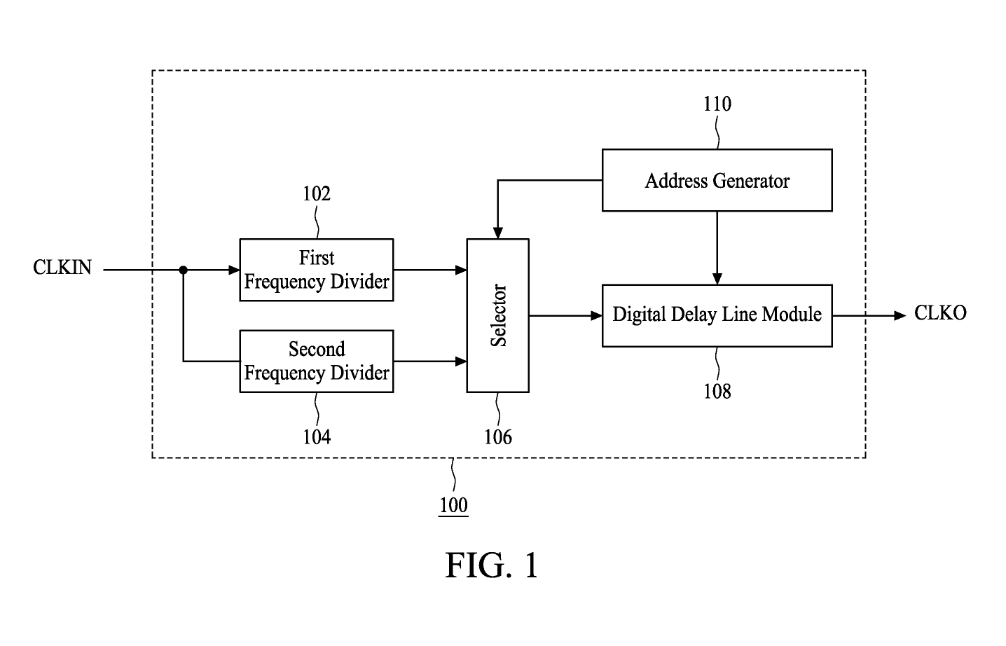

FIG. 2 is a waveform diagram illustrating waveforms of several signals of the prior art fractional-n clock generator;

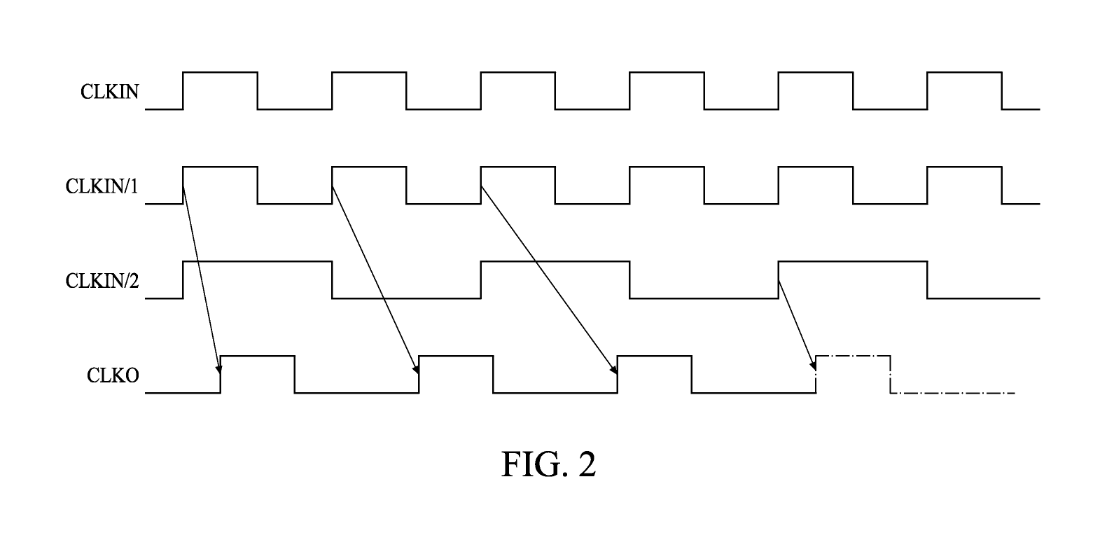

FIG. 3 is a schematic diagram illustrating a fractional-n clock generator according to an embodiment of the present invention;

FIG. 4 is a waveform diagram illustrating waveforms of several signals of a fractional-n clock generator according to an embodiment of the present invention;

FIG. 5 is another waveform diagram illustrating waveforms of several signals of a fractional-n clock generator according to an embodiment of the present invention;

FIG. 6 is a schematic diagram illustrating a fractional-n clock generator according to another embodiment of the present invention;

FIG. 7 is a waveform diagram illustrating waveforms of several signals of a fractional-n clock generator according to an embodiment of the present invention; and

FIG. 8 is a flow chart illustrating a fractional-n clock generation method according to an embodiment of the present invention.

### DESCRIPTION OF THE EMBODIMENTS

The present invention is directed to a fractional-n clock generator and a method thereof. In order for the present invention to be fully understood, detail steps and configurations are provided in the following description. Clearly, implementations of the present invention are not limited to the specific details people having ordinary skills in the art are familiar with. In addition, well known configurations or steps are not described in detail to avoid imposing unnecessary limitations on the present invention. The preferred embodiments of the present invention will be described in detail in the following. However, in addition to the detailed description, the present invention may be broadly implemented in other embodiments. The scope of the present invention is not limited by the detailed description and is defined by the appended claims.

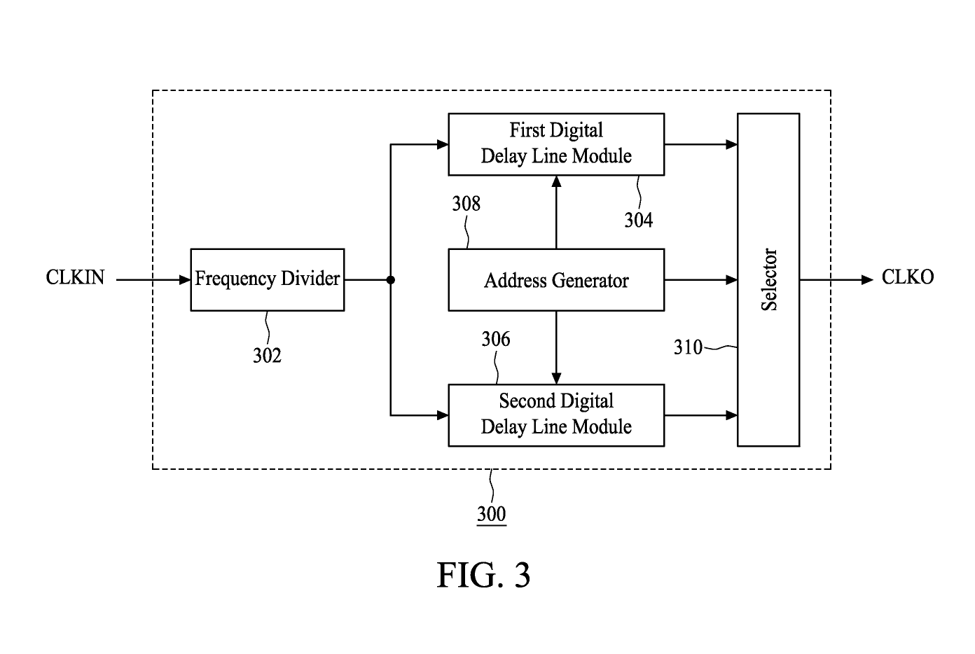

FIG. 3 is a schematic diagram illustrating a fractional-n clock generator 300 according to an embodiment of the present invention. As illustrated in FIG. 3, the fractional-n clock generator 300 includes a frequency divider 302, a first digital delay line module 304, a second digital delay line module 306, an address generator 308 and a selector 310. The frequency divider 302, configured to generate a frequency-divided signal by dividing its input signal by N, receives an external clock signal CLKIN and generates a frequency-divided clock signal CLKIN/N. The first digital delay line module 304, configured to receive the frequency-divided clock signal CLKIN/N, includes a plurality of first delay units to generate a plurality of first delay signals having different phase differences with respect to the frequency-divided clock signal CLKIN/N. The second digital delay line module 306, configured to receive the frequency-divided clock signal CLKIN/N, includes a plurality of second delay units to generate a plurality of second delay signals having different phase differences with respect to the frequency-divided clock signal CLKIN/N. The address generator 308 is configured to select one of the first delay signals as an output signal of the first digital delay line module 304 and select one of the second delay signals as an output signal of the second digital delay line module 306. The selector 310 is configured to select one of the output signals of the first digital delay line module 304 and the second digital delay line module 306 as an output signal. It is noted that a delay of the first digital delay line module 304 is not equal to that of the second digital delay line module 306.

In some of the embodiments of the present invention, the first delay units of the first digital delay line module 304 are connected in series, and the second delay units of the second digital delay line module 306 are connected in series.

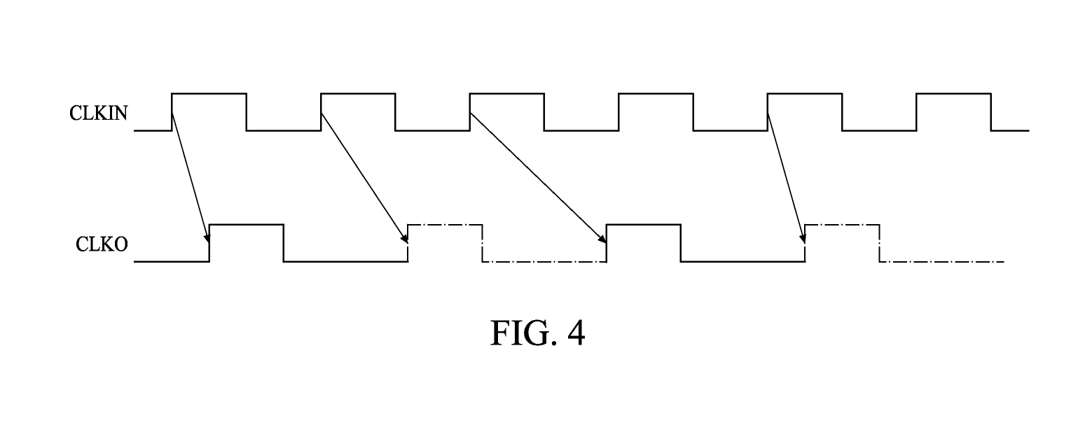

FIG. 4 is a waveform diagram illustrating waveforms of several signals of the fractional-n clock generator 300, wherein the fractional-n clock generator 300 is configured to generate an output clock signal CLKO with a frequency lower than that of the external clock signal CLKIN. According to the present embodiment, N is equal to 1. That is, the frequency divider 302 is configured to generate the frequency-divided clock signal CLKIN/1 by dividing its input signal by 1. As illustrated in FIG. 4, the solid line portion of the output clock signal CLKO of the fractional-n clock generator 300 represents the output signal of the first digital delay line module 304 and the dot-dashed line portion of the output clock signal CLKO represents the output signal of the second digital delay line module 306. During the first three clock cycles, delays of the output clock signal CLKO with respect to the frequency-divided clock signal CLLIN/1 do not exceed one period. The address generator 308 configures the first digital delay line module 304 and the second digital delay line module 306 to incrementally increase the number of stages of the delay units for each selection for the output signals, and the selector 310 alternatively selects one of the output signals of the first digital delay line module 304 and the second digital delay module 306 as the output signal of the fractional-n clock generator 300. Reference delay signals of the first three pulses of the output clock signal CLKO are the first three pulses of the frequency-divided clock signal CLKIN/1. During the fourth clock cycle, a delay of the output clock signal CLKO with respect to the frequency-divided clock signal CLKIN/1 is more than one period, and the selector 310 still keeps alternatively selecting from the output signals of the first digital delay line module 304 and the second digital delay line module 306. Accordingly, the fourth pulse of the frequency-divided clock signal CLKIN/1 is skipped and not used as a reference delay signal and the fifth pulse of the frequency-divided clock signal CLKIN/1 is used instead, as illustrated by arrows in FIG. 4, so as to avoid occurrence of an undesired pulse on the output clock signal CLKO.

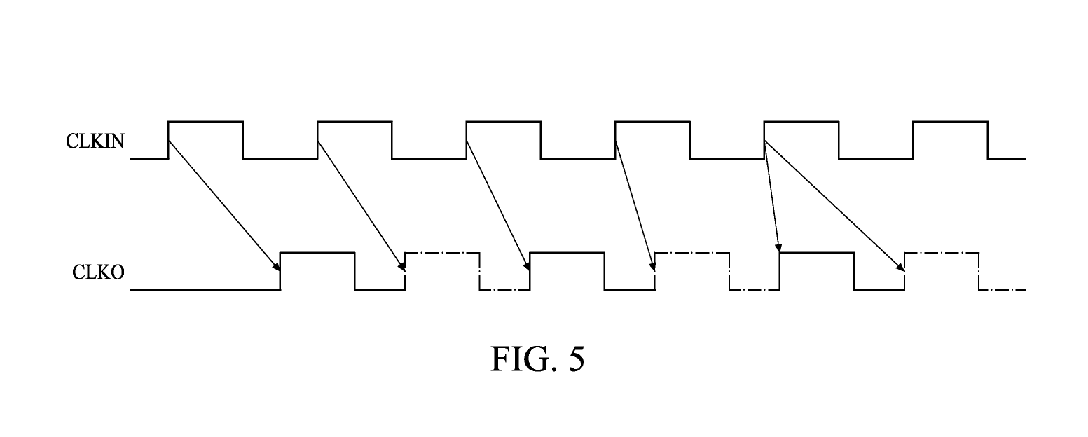

FIG. 5 is a waveform diagram illustrating waveforms of several signals of the fractional-n clock generator 300, wherein the fractional-n clock generator 300 is configured to generate an output clock signal CLKO with a frequency higher than that of the external clock signal CLKIN. Similar to the embodiment illustrated in FIG. 4, N is equal to 1 in the present embodiment. That is, the frequency divider 302 is configured to generate the frequency-divided clock signal CLKIN/1 by dividing its input signal by 1. Moreover, the solid line portion of the output clock signal CLKO of the fractional-n clock generator 300 represents the output signal of the first digital delay line module 304 and the dot-dashed line portion of the output clock signal CLKO represents the output signal of the second digital delay line module 306. The part of the present embodiment that is different from the embodiment of FIG. 4 is that because the fractional-n clock generator 300 is configured to generate the output clock signal CLKO with a frequency higher than that of the external clock signal CLKIN, the address generator 308 configures the first digital delay line module 304 and the second digital delay line module 306 to incrementally decrease the number of stages of the delay units for each selection for the output signals, and the selector 310 alternatively selects one of the output signals of the first digital delay line module 304 and the second digital delay line module as the output signal of the fractional-n clock generator 300. Accordingly, reference delay signals of the first five pulses of the output clock signal CLKO are the first five pulses of the frequency-divided clock signal CLKIN/1. However, since a triggering point of the sixth pulse of the output clock signal CLKO is still in the fifth clock cycle of the frequency-divided clock signal CLKIN/1, the sixth pulse of the output clock signal CLKO still uses the fifth pulse of the frequency-divided clock signal as a reference delay signal. In other words, the fifth pulse of the output clock signal CLKO is provided by the first digital delay line module 304 and the sixth pulse is provided by the second digital delay line module 306, and both of them use the fifth pulse of the frequency-divided clock signal CLKIN/1 as the reference delay signals.

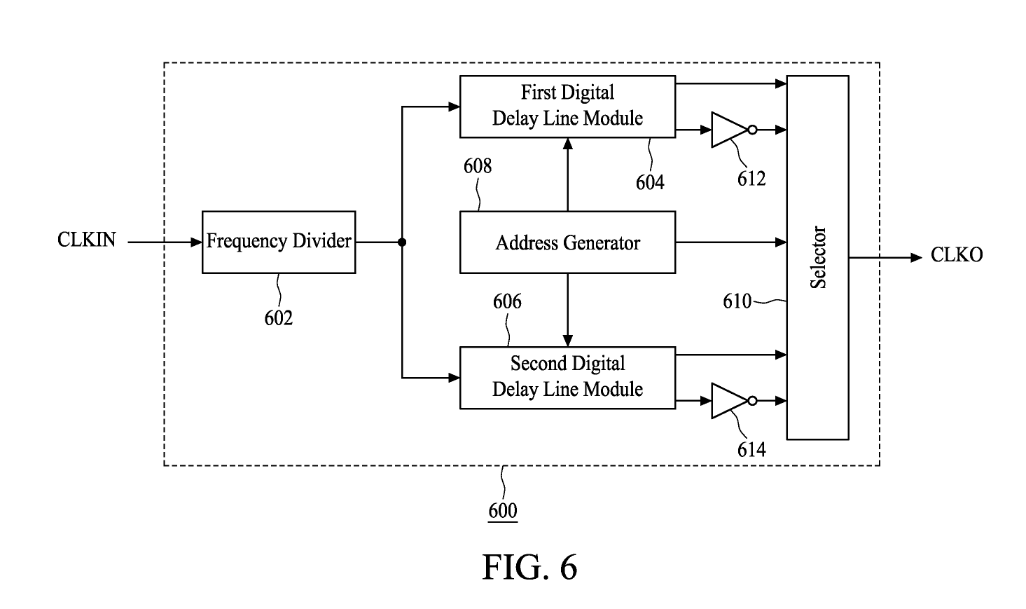

FIG. 6 is schematic diagram illustrating a fractional-n clock generator according to another embodiment of the present invention. As illustrated in FIG. 6, the fraction-n clock generator 600 includes a frequency divider 602, a first digital delay line module 604, a second digital delay line module 606, an address generator 608, a selector 610, a first inverter 612 and a second inverter 614. Compared to the fractional-n clock generator of FIG. 3, the fractional-n clock generator 600 of FIG. 6 further includes the first inverter 612 and the second inverter 614, wherein the first inverter 612 and the second inverter 614 respectively generate inverted signals of the first digital delay line module 604 and the second digital delay line module 606 as input signals to the selector 610. Accordingly, both a positive edge and a negative edge of a pulse of the frequency-divided clock signal CLKIN/N can be used as a reference for a pulse of the output signal of the fractional-n clock generator 600, and hence, the number of delay units in the first digital delay line module 604 and the second digital delay line module 606 may be reduced. In other words, in the present embodiment, a delay of the first digital delay line module 604 does not exceed half of a period of the frequency-divided clock signal CLKIN/N, and a delay of the second digital delay line module 606 does not exceed half of a period of the frequency-divided clock signal CLKIN/N.

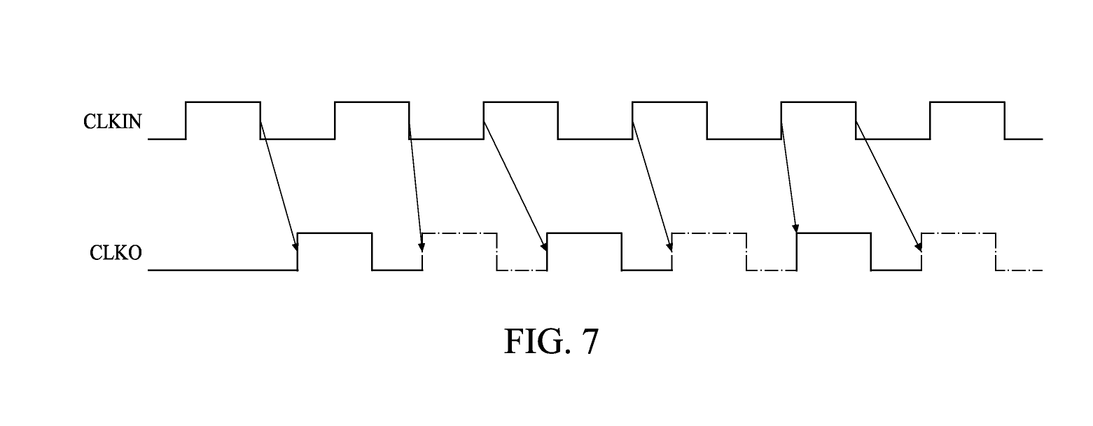

FIG. 7 is a waveform diagram illustrating waveforms of several signals of the fractional-n clock generator 600, wherein the fractional-n clock generator 600 is configured to generate an output clock signal CLKO with a frequency higher than that of the external clock signal CLKIN. Similar to the embodiment in FIG. 4, N is equal to 1 in the present embodiment. That is, the frequency divider 602 is configured to generate the frequency-divided signal CLKIN/1 by dividing its input signal by 1. In addition, the solid line portion of the output clock signal CLKO of the fractional-n clock generator 600 represents the output signal of the first digital delay line module 604 and the dot-dashed line portion of the output clock signal CLKO represents the output signal of the second digital delay line module 606. As illustrated in FIG. 7, if a delay of the output clock signal CLKO with respect to the frequency-divided signal CLKIN/1 exceeds half of a period, then the pulse of the output clock signal CLKO use a negative edge of the reference pulse in the frequency-divided clock signal CLKIN/1 as the reference triggering point.

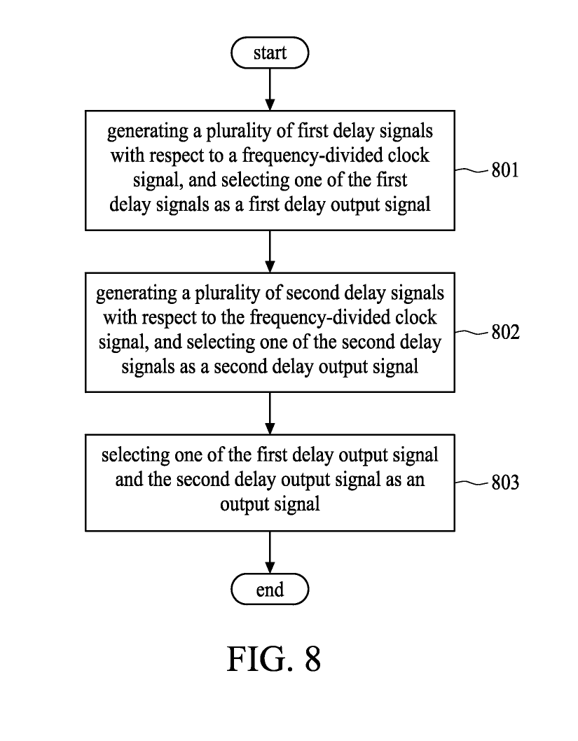

FIG. 8 is a flow chart illustrating a fractional-n clock generation method according to an embodiment of the present invention. The method can be applied in the fractional-n clock generators according to the embodiments of the present invention. In step 801, a plurality of first delay signals having different phase differences with respect to a frequency-divided clock signal are generated, and one of the first delay signals is selected as a first delay output signal. In step 802, a plurality of second delay signals having different phase differences with respect to the frequency-divided clock signal are generated, and one of the second delay signals are generated as a second delay output signal, which is followed by step 803. In step 803, one of the first delay output signal and the second delay output signal is selected as an output signal.

To summarize the foregoing description, the fractional-n clock generator and the method thereof according to the present invention use two digital delay line modules to respectively generate different delays with respect to a frequency-divided signal. Accordingly, the fractional-n clock generator and the method thereof according to the present invention may provide an output clock signal which has a frequency higher or lower than that of the frequency-divided clock signal.

Although the present invention and its advantages have been described in detail, it should be understood that various changes, substitutions and alterations can be made herein without departing from the spirit and scope of the invention as defined by the appended claims. For example, many of the processes discussed above can be implemented in different methodologies and replaced by other processes, or a combination thereof.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A fractional-n clock generator, comprising:
a first digital delay line module, configured to receive a frequency-divided clock signal and comprising a plurality of first delay units to generate a plurality of first delay signals having different phase differences with respect to the frequency-divided clock signal;
a second digital delay line module, configured to receive the frequency-divided clock signal and comprising a plurality of second delay units to generate a plurality of second delay signals having different phase differences with respect to the frequency-divided clock signal;
an address generator, configured to select one of the first delay signals as an output signal of the first digital delay line module and select one of the second delay signals as an output signal of the second digital delay line module; and
a selector, configured to select one of the output signals of the first digital delay line module and the second digital delay line module as a fractional-n clock signal,
wherein a delay of the first digital delay line module is not equal to a delay of the second digital delay time module.

2. The fractional-n clock generator according to claim 1, further comprising:
a frequency divider, configured to receive an external clock and generate the frequency-divided clock signal.

3. The fractional-n clock generator according to claim 1, wherein the selector alternatively selects one of the output signals of the first digital delay line module and the second digital delay line module as the output signal.

4. The fractional-n clock generator according to claim 1, wherein the first delay units are connected in series.

5. The fractional-n clock generator according to claim 1, wherein the second delay units are connected in series.

6. The fractional-n clock generator according to claim 1, wherein the delays of the first digital delay line module and the second digital delay line module do not exceed half of a period of the frequency-divided clock signal.

7. The fractional-n clock generator according to claim 1, further comprising:
a first inverter, configured to generate an inverted signal of the first digital delay line module as the input signal of the selector.

8. The fractional-n clock generator according to claim 1, further comprising:
a second inverter, configured to generate an inverted signal of the second digital delay line module as the input signal of the selector.

9. A fractional-n clock generation method, comprising the steps of:
generating a plurality of first delay signals having different phase differences with respect to a frequency-divided clock signal, and selecting one of the first delay signals as a first delay output signal;
generating a plurality of second delay signals having different phase differences with respect to the frequency-divided clock signal, and selecting one of the second delay signals as a second delay output signal; and
selecting one of the first delay output signal and the second delay output signal as a fractional-n clock signal.

10. The fractional-n clock generation method according to claim 9, wherein the selecting step involves alternatively selecting one of the first delay output signal and the second delay output signal as the fractional-n clock signal.
